(19) United States
(12) Patent Application Publication
(10) Pub. No.: US 2013/0188354 A1
(43) Pub. Date: Jul. 25, 2013

(54) PHOSPHOR COATING FILMS AND LIGHTING APPARATUSES USING THE SAME

(71) Applicants: Yuh-Ren Shieh, Hong Kong (CN); Ping Kuen Eddie Li, Hong Kong (CN)

(72) Inventors: Yuh-Ren Shieh, Hong Kong (CN); Ping Kuen Eddie Li, Hong Kong (CN)

(73) Assignee: Huizhou Light Engine Limited (a Chinese limited company), Huizhou City, Guangdong (CN)

(21) Appl. No.: 13/811,218

(22) PCT Filed: Dec. 1, 2010
(86) PCT No.: PCT/CN2010/079342

§ 371 Date: Mar. 21, 2013

Related U.S. Application Data
(60) Provisional application No. 61/365,572, filed on Jul. 19, 2010.
(60) Provisional application No. 61/416,916, filed on Nov. 24, 2010.

(51) Int. Cl. F21V 13/08; F21V 13/12

(52) U.S. Cl. CPC F21V 13/08; F21V 13/12
USPC 362/235

(57) ABSTRACT

A lighting apparatus includes a circuit board having a highly reflective top surface; at least one LED chip mounted on the top surface of the circuit board, the at least one LED chip being operable to emit light of a first color. A phosphor film having an arcuate inner surface is configured to maintain a predetermined finite distance from the at least one LED chip, the phosphor film being disposed such that light emitted from the LED chip radiates upon the phosphor film, the inner surface of the phosphor film hooding the top surface of the circuit board so as to form a multi-reflection zone to reduce light absorption by the at least one LED chip and reduce direct light leakage from between the phosphor film and the top surface of the circuit board. The phosphor film containing phosphors that down convert at least a portion of the light of the first color into light of a second color, that when mixed together with the first color produces visible white light.

### CROSS-REFERENCE TO RELATED APPLICATION

This PCT application claims priority to U.S. Provisional Patent Application Ser. No. 61/365,572, filed Jul. 9, 2010, and U.S. Provisional Patent Application Ser. No. 61/416,916, filed Nov. 24, 2010, which are hereby incorporated by reference herein.

Throughout this application, several references are referenced herein. Disclosure of these references in their entirety is hereby incorporated by reference in this provisional application.

### BACKGROUND OF THE INVENTION

The present invention relates to a lighting apparatus used for lighting. In a preferred embodiment, the lighting apparatus is an LED light source that includes one or more LED chips disposed on a reflective surface to emit short wavelength light, a separate remote phosphor covering the reflective surface at a finite distance away from LED chip surface to convert at least a portion of the light emitted from LED to a longer wavelength, and a transparent (or diffusive) cover. The lighting apparatus may comprise a luminaire.

Conventionally, white LED lamps for lighting often include blue LED chips packaged with phosphor and encapsulant. The phosphor in such lamps, when irradiated by the blue light from the LED, converts the blue light into yellow light. The blue and yellow light thus emitted combine to form white light.

In some prior art devices, the conversion efficiency of the phosphor is reduced due to the direct heating of the phosphor by the LED chips. Also, a portion of the converted light, i.e., a portion of the light produced by the phosphor, will be reflected back into the LED chips by the phosphor coated on its surface. And it is then absorbed by internal structure of LED chips.

Furthermore, to form the array of such LED lamps for lighting applications, the white light emitted from such LED lamps is fine (or narrow) color and brightness binning is necessary to ensure uniformity of the light output of the lamp.

To further obtain more uniform light illumination without hot spots for such an LED lamp, a cover having a high light diffusion (haze) is used. However, the use of such a cover can result in a lower efficacy of the lamp, due to the lower overall light transmission that results from the diffusion.

An example of a conventional lamp is shown by U.S. Pat. No. 7,319,246 to Soules at al. (The '246 patent). In the device disclosed in the '246 patent, a semiconductor lighting device, such as an LED, is used in conjunction with a luminophor, or phosphor, such that the light emitted from the LED, when combined with the light from the luminophor, produces white light.

In the device disclosed in the '246 patent, a lighting apparatus comprising an LED is disposed on an interconnect board. A polymeric layer including the luminophor is disposed about the lighting apparatus to convert the radiation emitted from the LED into visible, preferably white, light. The polymeric layer is shrinkable to conform to a shape enclosing the light emitting diode.

The phosphor powder, such as yttrium aluminum garnet (YAG), is embedded in the polymeric wrap material that is formed into a sheet. The formed polymeric phosphor sheet is rolled into a roll. The polymeric phosphor roll is cut into pieces of appropriate sizes as required to produce the shrink-wrap to be wrapped around LEDs, enclosure and other objects which can take various shapes and sizes. When heated, the polymeric shrink-wrap shrinks and conforms to the outer surface shape around the object or objects containing the LEDs.

U.S. Pat. No. 7,618,157 to Galvez et al. discloses a tubular blue LED lamp with a phosphor. In this patent, a lamp is provided that includes a linearly extending heat sink, blue-light-emitting LEDs mounted on the heat sink, and a light emitting cover mounted on the heat sink in line with the LEDs. A first portion of the cover opposite the LEDs includes a phosphor that is excited by the light from the LEDs to emit white light. The cover may be a tube, a portion of the tube nearest the LEDs being transparent and receiving light from the LEDs. The tube may include reflectors that are attached to an exterior surface of the tube to hold the tube on the heat sink. Alternatively, the cover may enclose the LEDs on the heat sink, where a portion of the cover has an interior surface that reflects light from the LEDs to the first portion of the cover. The angled reflectors as a 2nd portion of the cover are used to multi-reflect light between LEDs and a transparent 1st portion of cover coated by phosphor. The cover structure is complicated with low efficiency without a good reflectivity of circuit board where the LEDs are disposed.

Similar examples shown in U.S. Pat. No. 7,703,942 to Narendran et al. introduce an optics device to receive light emitted from LED and convert the light into another spectral region by remote phosphor coated on its top surface. The multi-reflection surface where LED disposed is ignored.

U.S. Pat. Pub. No. 2010/124243 relates to a light apparatus that includes an elongated hollow wavelength conversion tube that includes an elongated wavelength conversion tube wall having phosphor dispersed therein. An LED is oriented inside the elongated hollow wavelength conversion tube to emit light so as to impinge upon the elongated wavelength conversion tube wall and the wavelength conversion material, e.g., a phosphor, dispersed therein. The elongated hollow wavelength conversion tube may have an open end, a crimped end, a reflective end, and/or other configurations. Again there is no multi-reflection surface where the LED is disposed.

U.S. Pat. Pub. No. 6,583,550 relates to an LED light tube constituted by a fluorescent tubular body having a transparent glass tube fully coated with a fluorescent layer on its inner wall. Due to the directional light emission of LEDs, the area of fluorescent layer opposite to light emitting from an LED is wasted. And the reflective surface where LED is disposed is not utilized as a multi-reflection surface.

### BRIEF SUMMARY OF THE INVENTION

In accordance with a first aspect of the present invention, a lighting apparatus comprises: a circuit board having a highly reflective top surface; at least one LED chip mounted on the top surface of the circuit board, the at least one LED chip being operable to emit light of a first color: a phosphor film having an arcuate inner surface configured so as to maintain a predetermined finite distance from the at least one LED chip, the phosphor film being disposed such that light emitted from the LED chip radiates upon the phosphor film, the inner surface of the phosphor film hooding the top surface of the circuit board so as to form a multi-reflection zone to reduce light absorption by the at least one LED chip and reduce direct light leakage from between the phosphor film and the top surface of the circuit board, the phosphor film containing phosphors that down convert at least a portion of the light of the first color emitted by the at least one LED chip into light of a second color, having a longer wavelength than the first color, the first and second colors, when mixed together producing visible white light.

In another aspect, the lighting apparatus further comprises: a heat sink having a top surface on which the circuit board is mounted, the heatsink being disposed on a side of the circuit board opposed to the at least one LED chip to dissipate heat generated by the at least one LED chip; and a low light diffusing or transparent cover including a lower edge configured to mate with the heat sink and to enclose the phosphor film.

In another aspect, the lighting apparatus further comprises a thermal paste or grease between the circuit board and the heat sink.

In another aspect, the phosphor film has a multi layer structure composed of phosphor layers and a transparent supporting layer.

In another aspect, the transparent supporting layer is made of transparent polymer selected from the group consisting of Polypropylene (PP), Polyethylene (PE), Polycarbonate (PC), Polyphthalamide (PPA) and Polyurethane (PU).

In another aspect, the transparent supporting layer is made of glass.

In another aspect, the phosphor film has a transparent layer containing multi-phosphor particles uniformly dispersed.

In another aspect, the transparent layer is made of transparent polymer selected from the group consisting of Polypropylene (PP), Polyethylene (PE), Polycarbonate (PC), Polyphthalamide (PPA) and Polyurethane (PU).

In another aspect, the transparent layer is made of glass.

In another aspect, the at least one LED chip is bonded and encapsulated on the circuit board.

In another aspect, the light of the first color is in a wavelength range of between 300˜500 nm.

In another aspect, the light of the second color is in a wavelength range of between 500˜700 nm.

In another aspect, the heatsink includes a plurality of wings.

In another aspect, the at least one LED chip is mounted on the top surface of the circuit board by chip-on-board (COB) with silicone encapsulation.

In another aspect, the top surface of the circuit board is made of PCB, MCPCB, ceramic, or enamel with (or without) solder mask.

In another aspect, the at least one LED chip is packaged with a lead frame, and mounted on the top surface of the circuit board by a surface mount (SMT) or through-hole technique.

In accordance with a second aspect of the present invention, a lighting apparatus comprises: a circuit board with a highly light reflective top surface made of PCB, MCPCB, ceramic, or enamel with (or without) solder mask; at least one LED chip mounted on a highly reflective top surface of the circuit board, the at least one LED chip being operable to emit light of a first color; an phosphor film (i) having an arcuate inner surface configured so as to maintain a predetermined finite distance from the at least one LED chip, the phosphor film being disposed such that light emitted from the at least one LED chip completely and uniformly radiates upon the phosphor film, (ii) having an opening to hood the high reflective top surface of the circuit board such that a light multi-reflection zone is formed to reduce the light absorption by the at least one LED chip with little direct light leakage from gaps between the phosphor film and the highly reflective surface of circuit board, (iii) the phosphor film containing phosphors that down convert at least a portion of the light, in a range from 300˜500 nm, of the first color emitted by the at least one LED chip into light with longer wavelength, in a range from 500˜700 nm, of a second color, that when mixed together with the first color produces visible white light.

In another aspect, the lighting apparatus further comprises: a heat sink having a top surface on which the circuit board is mounted, the heatsink being disposed on a side of the circuit board opposed to the at least one LED chip to dissipate heat generated by the at least one LED chip, and a low light diffusing (or transparent) cover is configured to mate with the heat sink and to enclose the phosphor film.

In another aspect, the lighting apparatus further comprises a thermal paste or grease between the circuit board and the heat sink.

In another aspect, the phosphor film has a multi layer structure composed of phosphor layers and a transparent supporting layer.

In another aspect, the phosphor film has a transparent layer containing multi-phosphor particles uniformly dispersed.

In another aspect, the at least one LED chip is bonded and encapsulated on the circuit board.

In another aspect, the lighting apparatus is a tubular embodiment or a hemispherical embodiment with an axial symmetry.

In another aspect, the heatsink includes a plurality of wings.

In another aspect, the at least one LED chip is mounted on the highly reflective top surface of the circuit board by chip-on-board (COB) with silicone encapsulation.

In another aspect, the lighting apparatus is a luminaire.

In another aspect, the silicone encapsulation is transparent.

In another aspect, the silicone encapsulation is mixed with a phosphor having a different dominant wavelength from that of the phosphor film.

In another aspect, the at least one LED chip is packaged with a lead frame, and mounted on the top surface of the circuit board by a surface mount (SMT) or through-hole technique.

### BRIEF DESCRIPTION OF TILE DRAWINGS

The figures are for illustration purposes only and are not necessarily drawn to scale. The invention itself, however, may best be understood by reference to the detailed description which follows when taken in conjunction with the accompanying drawings in which:

FIG. 1 is a cross-sectional view of an assembled lighting apparatus in accordance with an embodiment of the present invention;

FIG. 2 is a perspective view of the assembled lighting apparatus in accordance with an embodiment of the present invention FIG. 1;

FIGS. 3-5 are cutaway, side and perspective views, respectively, of a hemispherical embodiment of the present invention.

FIG. 6 is a diagram of the electrical connection of the LEDs in a serial connection of parallel LED modules in accordance with an aspect of the present invention; and

FIG. 7 is a diagram of the electrical connection of the LEDs in a parallel connection of serial LED modules in accordance with another aspect of the present invention.

### DETAILED DESCRIPTION OF THE INVENTION

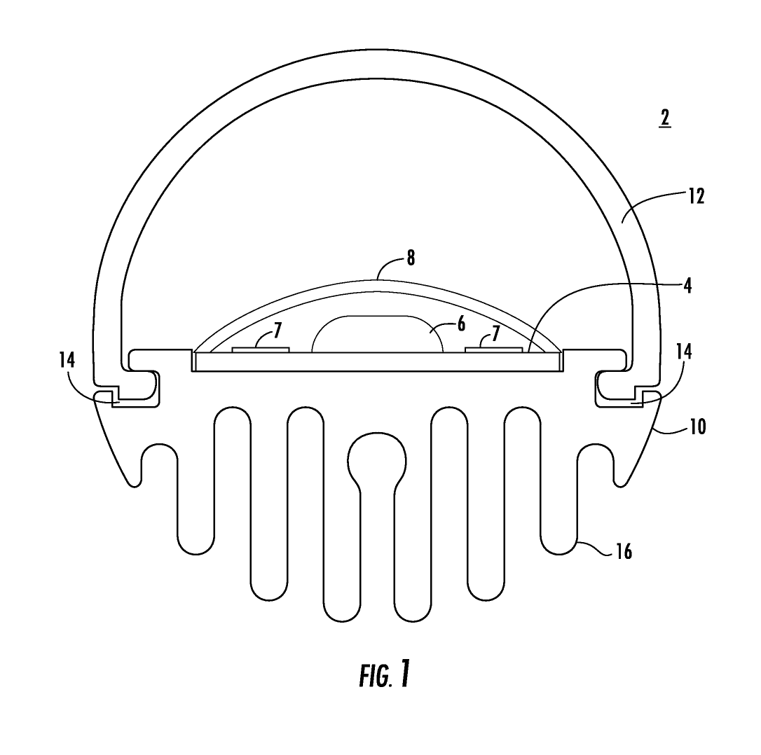

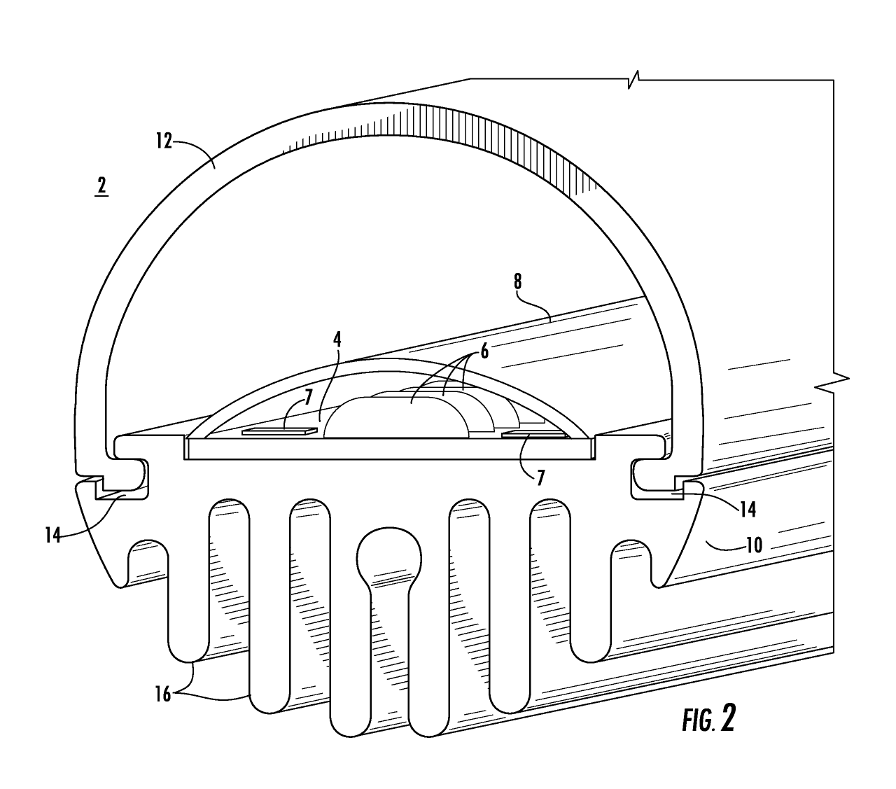

FIGS. 1 and 2 illustrate a first preferred embodiment of an LED lighting apparatus, which may be a luminaire, in accordance with the present invention. As can be seen in the figures, an LED lighting apparatus 2 in accordance with the present invention is formed of a circuit board (CB) 4, at least one LED chip 6 mounted on the CB 4, a phosphor film 8, provided remotely from the LED chip 6, a heat sink 10 and a cover 12 mounted to the heat sink 10 having fins or wings 16. Also on the CB 4 are soldering pads 7 for electrical connections. The heat sink 10 functions to dissipate heat generated by the at least one LED chip 6.

FIG. 1 is a cross-sectional view of the LED lighting apparatus in accordance with one aspect of the present invention in its assembled state. As shown for example in FIG. 1, the LED chips 6, which can be part of an array of LED chips, are bonded on a highly reflective CB 4. The phosphor film 8 is substantially arcuate in profile to maintain a predetermined distance from the LED chip 6. The arcuate phosphor film 8 hoods the highly reflective CB 4 on the heat sink 10, and is enclosed by the cover 12.

The top surface of the CB 4 is preferably highly reflective and preferably is made from PCB, MCPCB, ceramic or enamel with or without solder mask. The LED chips 6 are preferably mounted on the top surface of the CB 4 by the “chip-on-board” (COB) technique with silicone encapsulation. The encapsulation can be transparent, or alternatively, it can be mixed with a phosphor of a different dominant wavelength than that of the phosphor film 8, so that the color temperature of the LED can be further changed, for example to a lower color temperature by the phosphor film. The invention is not limited to the use of COB, and, for example, the LED chips may be LED chips packaged with a lead frame, mounted on the CB 4 by a surface mount (SMT) or through-hole technique.

The phosphor film 8 is preferably a double layer structure composed of a phosphor layer on a transparent supporting layer situated between the cover 12 and LED light source 6. Alternatively, it can have multiple layers. The phosphor layer may be single color, or multi-color phosphors, such as cerium doped YAG, Silica or other conventional phosphor. The phosphor film's transparent layer may contain multi-phosphor particles uniformly distributed therein. In either case, the transparent layer may be made of polymer, such as Polypropylene (PP), Polyethylene (PE), Polycarbonate (PC), Polyphthalamide (PPA) and polyurethane (PU), or similar materials. Alternatively, the transparent layer could be made of glass.

The cover 12 is preferably a transparent, frosted or otherwise light diffusing cover that softens the light coining from the LED lighting apparatus. The cover 12, is shaped at its lower edges so as to couple, for example by a snap-fit or sliding fit, to the heat sink 10. The cover 12 is preferably made of transparent poly mer such as PC, PMMA, PVC or PU having a high light transmissivity, or other plastic or glass, or any other material that can pass light exiting the lighting apparatus. The cover 12 and the heat sink 10 can mate with each other by a snap fit, or any other appropriate manner of attachment. For example, the cover 12 can be mated with the heat sink 10 by sliding its lower edges into receiving slots 14 at the edges of the heat sink 10. In a tubular embodiment, such as the one shown in FIG. 2, an assembled lighting apparatus may preferably have end caps at either or both ends of the lighting apparatus.

In operation, the LED chip 6 in accordance with the present invention emits light. The light from the LED chip 6, which is preferably in the wavelength range of about 300˜500 nm, radiates upon the phosphor film 8, which includes, or is coated with, a phosphor that down converts some of the emitted light with shorter wavelength such as blue from the LED to light with longer wavelengths, such as yellow, preferably in the wavelength range of about 500˜700 nm, which, when combined with the blue light, produces a white light.

The lighting apparatus 2 is configured with a light multi-reflection zone between the phosphor film 8 and the LED chip 6, reducing the amount of the reflected light that is directly absorbed by the LED chip 6, compared to the case where the phosphor is located directly in contact with the LED in conventional devices. To further assist in reducing a loss of light, the CB 4 is preferably highly reflective, to minimize loss due to multi-reflection between the phosphor film 8 and the CB 4. By virtue of the configuration of the present invention, a 20˜60% higher efficiency can be obtained in comparison with traditional-phosphor coated lamps.

The lighting apparatus 2 also is configured such that the phosphor film 8 is not a part of, or attached to, the cover 12. Separating the phosphor film 8 from the cover 12 allows the color of the phosphor film to be better shaded if a diffusive cover 12 is utilized. And in this case an even better light diffusion (uniformity) can be obtained.

For better thermal conduction, preferably a thermal paste or grease is applied between the back side of the CB 4 and the heat sink 10. The heat sink 10 is preferably made of Al, an Al alloy, Cu, ceramic, plastic, or other appropriate material with high heat conductivity, and is shaped, stamped or otherwise formed to have heat dissipating fins or wings 16 to provide greater surface area to allow heat to escape.

If a blue LED chip 6 is utilized, the phosphor used in the phosphor film 8 is one that produces a complimentary color such as yellow-green. The combination of the blue light and the yellow-green light produces white light. For such uses, the phosphor is preferably a conventional cerium doped YAG phosphor, Silica or other conventional phosphor, that may vary in composition and/or concentration depending upon the light characteristics desired. Alternatively, white light can be produced by using ultraviolet or near-ultraviolet LEDs, with appropriate phosphors of a type known to those skilled in the art. The LED chips can be vertical or horizontal, or a combination of both.

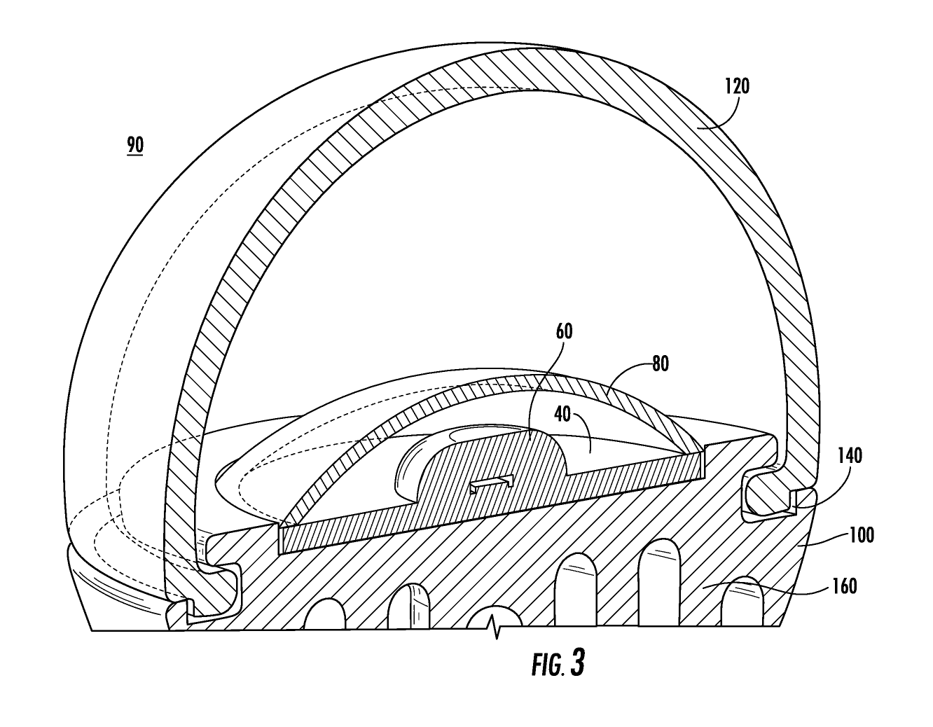

The foregoing description has been described in terms of a tubular embodiment. However, the present invention is applicable to other shapes as well. For example. FIGS. 3-5 show a hemispherical lighting apparatus 90 in accordance with the present invention. The hemispherical lighting apparatus 90 includes a CB 40, at least one LED chip 60 mounted on the CB 40, a phosphor film 80, provided remotely from the LED chip 60, a heat sink 100 and a cover 120 mounted to the heat sink 100 having fins or wings 160.

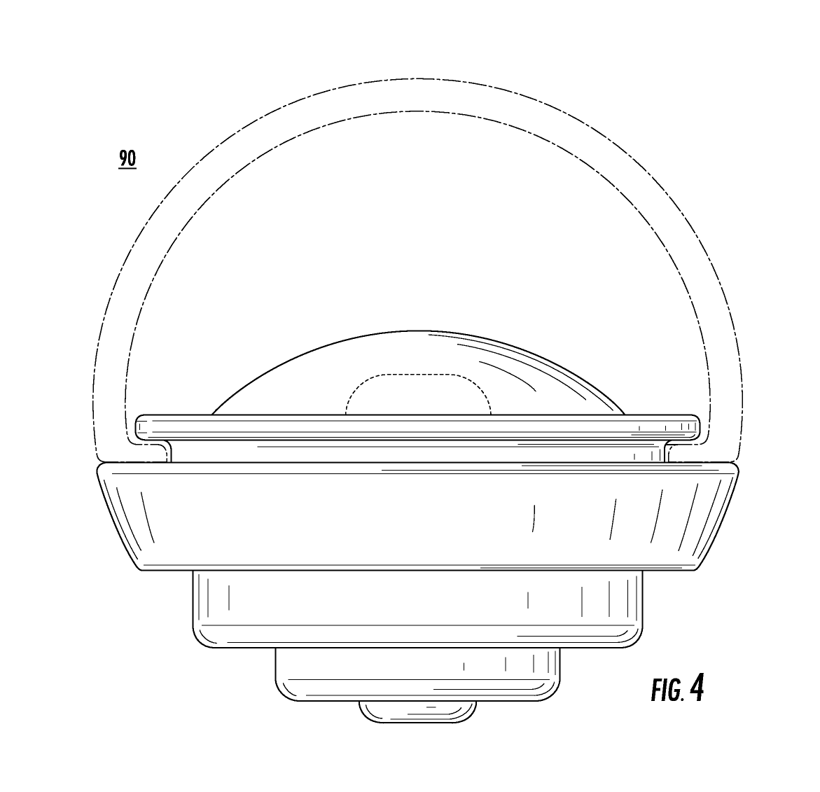

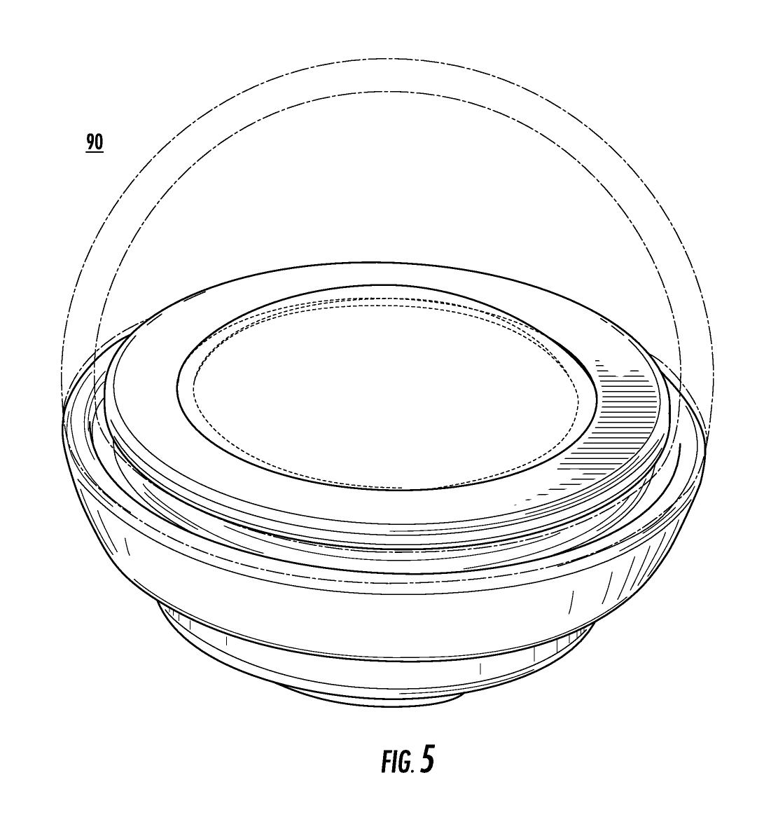

FIG. 3 is a cross-sectional view of the hemispherical embodiment of the LED lighting apparatus in accordance with the present invention in its assembled state. FIGS. 4 and 5 are side and perspective views, respectively, of a hemispherical embodiment of the present invention. As shown for example in FIG. 3, just as in the tubular embodiment, the LED chip 60, which can be part of an array of LED chips, is bonded on a highly reflective CB 40. The phosphor film 80 is substantially arcuate in profile to maintain a predetermined distance from the LED chip 60. The arcuate phosphor film 80 hoods the highly reflective CB 40 on the heat sink 100, and is enclosed by the cover 120. The function and materials of the components and operation of the hemispherical embodiment is the same as that described above in relation to the corresponding components in the tubular embodiment, and that description is therefore not repeated here.

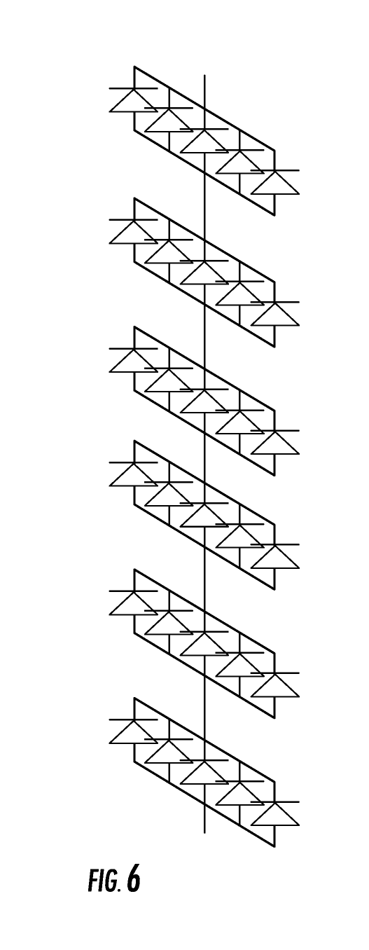

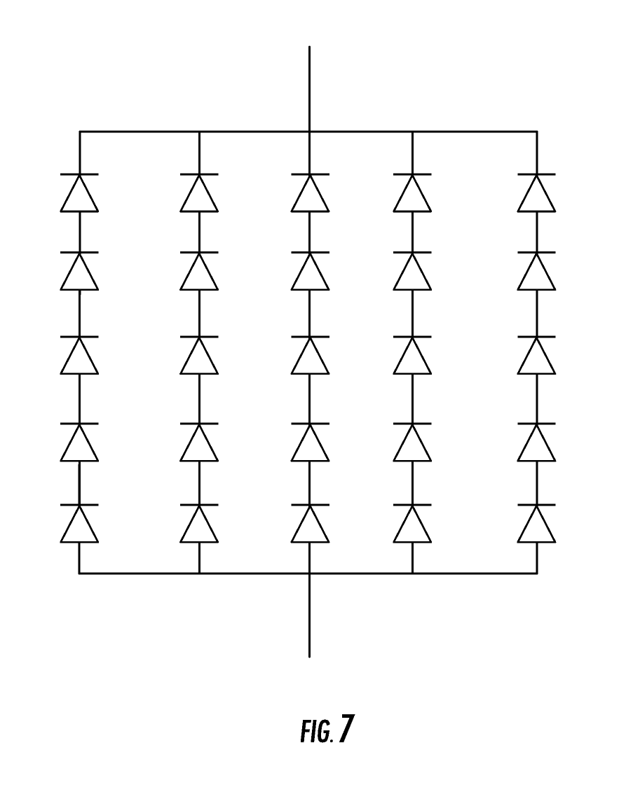

The electrical connection of plural LED chips within the circuit board can preferably be by means of a serial connection of parallel LED modules, as shown in FIG. 6. Alternatively, the connection can be by a parallel connection of serial LED modules, as shown in FIG. 7.

Although specific embodiments have been illustrated and described herein, it will be appreciated by those of ordinary skill in the art that a variety of alternate and/or equivalent implementations may be substituted for the specific embodiments shown and described without departing from the scope of the present invention. This provisional application is intended to cover any adaptations or variations of the specific embodiments discussed herein. Therefore, it is intended that this invention be limited only by the claims and the equivalents thereof.

1. A lighting apparatus comprising:
a circuit board having a highly reflective top surface;
at least one LED chip mounted on the top surface of the circuit board, the at least one LED chip being operable to emit light of a first color;
a phosphor film having an arcuate inner surface configured so as to maintain a predetermined finite distance from the at least one LED chip, the phosphor film being disposed such that light emitted from the LED chip radiates upon the phosphor film, the inner surface of the phosphor film hooding the top surface of the circuit board so as to form a multi-reflection zone to reduce light absorption by the at least one LED chip and reduce direct light leakage from between the phosphor film and the top surface of the circuit board, the phosphor film containing phosphors that down convert at least a portion of the light of the first color emitted by the at least one LED chip into light of a second color, having a longer wavelength than the first color, the first and second colors, when mixed together producing visible white light.

2. The lighting apparatus according to claim 1, further comprising:
a heat sink having a top surface on which the circuit board is mounted, the heatsink being disposed on a side of the circuit board opposed to the at least one LED chip to dissipate heat generated by the at least one LED chip; and
a low light diffusing or transparent cover including a lower edge configured to mate with the heat sink and to enclose the phosphor film.

3. The lighting apparatus according to claim 1, further comprising a thermal paste or grease between the circuit board and the heat sink.

4. The lighting apparatus according to claim 1, wherein the phosphor film has a multi layer structure composed of phosphor layers and a transparent supporting layer.

5. The lighting apparatus according to claim 1, wherein the phosphor film has a transparent layer containing multi-phosphor particles uniformly dispersed.

6. The lighting apparatus according to claim 1, wherein the at least one LED chip is bonded and encapsulated on the circuit board.

7. The lighting apparatus according to claim 1, wherein the light of the first color is in a wavelength range of between 300˜500 nm.

8. The lighting apparatus according to claim 1, wherein the light of the second color is in a wavelength range of between 500˜700 nm.

9. The lighting apparatus according to claim 2, wherein the heatsink includes a plurality of wings.

10. The lighting apparatus according to claim 2, wherein the at least one LED chip is mounted on the top surface of the circuit board by chip-on-board (COB) with silicone encapsulation.

11. The lighting apparatus according to claim 2, wherein the top surface of the circuit board is made of PCB, MCPCB, ceramic, or enamel with (or without) solder mask.

12. The lighting apparatus according to claim 2, wherein the at least one LED chip is packaged with a lead frame, and mounted on the top surface of the circuit board by a surface mount (SMT) or through-hole technique.

13. A lighting apparatus comprising:
a circuit board with a highly light reflective top surface made of PCB, MCPCB, ceramic, or enamel with (or without) solder mask;
at least one LED chip mounted on a highly reflective top surface of the circuit board, the at least one LED chip being operable to emit light of a first color;
an phosphor film (i) having an arcuate inner surface configured so as to maintain a predetermined finite distance from the at least one LED chip, the phosphor film being disposed such that light emitted from the at least one LED chip completely and uniformly radiates upon the phosphor film, (ii) having an opening to hood the high reflective top surface of the circuit board such that a light multi-reflection zone is formed to reduce the light absorption by the at least one LED chip with little direct light leakage from gaps between the phosphor film and the highly reflective surface of circuit board, (iii) the phosphor film containing phosphors that down convert at least a portion of the light, in a range from 300˜500 nm, of the first color emitted by the at least one LED chip into light with longer wavelength, in a range from 500˜700 nm, of a second color, that when mixed together with the first color produces visible white light.

14. The lighting apparatus according to claim 13, further comprising:
a heat sink having a top surface on which the circuit board is mounted, the heatsink being disposed on a side of the circuit board opposed to the at least one LED chip to dissipate heat generated by the at least one LED chip; and
a low light diffusing (or transparent) cover is configured to mate with the heat sink and to enclose the phosphor film.

15. The lighting apparatus according to claim 13, further comprising a thermal paste or grease between the circuit board and the heat sink.

16. The lighting apparatus according to claim 13, wherein the phosphor film has a multi layer structure composed of phosphor layers and a transparent supporting layer.

17. The lighting apparatus according to claim 13, wherein the phosphor film has a transparent layer containing multi-phosphor particles uniformly dispersed.

18. The lighting apparatus according to claim 13, wherein the at least one LED chip is bonded and

19. The lighting apparatus according to claim 1, wherein the lighting apparatus is a tubular embodiment or a hemispherical embodiment with an axial symmetry.

20. The lighting apparatus according to claim 14, wherein the heatsink includes a plurality of wings.

21. The lighting apparatus according to claim 13, wherein the at least one LED chip is mounted on the highly reflective top surface of the circuit board by chip-on-board (COB) with silicone encapsulation.

22. The lighting apparatus according to claim 1, wherein the lighting apparatus is a luminaire.

23. The lighting apparatus according to claim 10, wherein the silicone encapsulation is transparent.

24. The lighting apparatus according to claim 10, wherein the silicone encapsulation is mixed with a phosphor having a different dominant wavelength from that of the phosphor film.

25. The lighting apparatus according to claim 13, wherein the at least one LED chip is packaged with a lead frame, and mounted on the top surface of the circuit board by a surface mount (SMT) or through-hole technique.

26. The lighting apparatus according to claim 4, wherein the transparent supporting layer is made of transparent polymer selected from the group consisting of Polypropylene (PP), Polyethylene (PE), Polycarbonate (PC), Polyphthalamide (PPA) and Polyurethane (PU).

27. The lighting apparatus according to claim 4, wherein the transparent supporting layer is made of glass.

28. The lighting apparatus according to claim 5, wherein the transparent layer is made of transparent polymer selected from the group consisting of Polypropylene (PP), Polyethylene (PE), Polycarbonate (PC), Polyphthalamide (PPA) and Polyurethane (PU).

29. The lighting apparatus according to claim 5, wherein the transparent layer is made of glass.
